(19) United States
(12) Patent Application Publication
(10) Pub. No.: US 2006/0238740 A1
(43) Pub. Date: Oct. 26, 2006

(54) Electronic device and support mechanism thereof

(75) Inventor: Tsung-Te Lin, Taipei City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/370,989

(22) Filed: Mar. 9, 2006

(30) Foreign Application Priority Data
Mar. 10, 2005 (TW) 94107266

(51) Int. Cl. G03B 27/00

(52) U.S. Cl. 355/408

(57) ABSTRACT

An electronic device and support mechanism thereof. A first body is pivoted to a second body and capable of rotating between a first position and a second position with respect to the second body to close or open the electronic device respectively. A support member is connected to the first body, a position module is pivoted to the second body and a first spring is connected to the position module and the second body. When the electronic device is opened, the support member is moved by the first body rotating from the first position to the second position, thereby the position module rotates and joins with the support member to position the first body. When the support member is released from the position module, the first spring pulls the position module back, thereby the first body rotates from the second position to the first position to close the electronic device.

### BACKGROUND

The invention relates to an electronic device with a support mechanism.

Referring to FIG. 1, in a conventional multi-function printer 100, a scan module 10 is pivoted to a main body 20. When the ink cartridge is to be replaced or jammed paper is to be removed, the scan module 10 must be opened and supported by a support rod 30 to facilitate the described operation. In such a structure, when the operation is completed and the scan module 10 is to be closed, the support rod 30 must be pushed into a groove 40 in a direction A, whereby the scan module 10 can be smoothly closed.

FIG. 2 depicts another conventional multi-function printer 200. The multi-function printer 200 employs a rigid spring 130 connecting a scan module 110 and a main body 120. The scan module 110 is supported by the rigid spring 130 and is pushed to compress the rigid spring 130 when closed.

### SUMMARY

An electronic device according to an embodiment of the invention comprises a first body pivoted to a second body. The first body is capable of rotating between a first position and a second position with respect to the second body to close or open the electronic device respectively. A support member is connected to the first body, a position module is pivoted to the second body, and a first spring is connected to the position module and the second body. When the electronic device is opened, the support member is moved by the first body rotating from the first position to the second position, thereby the position module rotates and joins with the support member to position the first body. When the support member is released from the position module, the first spring pulls the position module back, thereby the first body rotates from the second position to the first position to close the electronic device.

### BRIEF DESCRIPTION OF THE DRAWINGS

The invention can be more fully understood by reading the subsequent detailed description and examples with references made to the accompanying drawings, wherein:

FIG. 1 is a schematic view of a conventional multi-function printer;

FIG. 2 is a schematic view of another conventional multi-function printer;

FIG. 3 is a schematic view of an embodiment of a multi-function printer according to the invention;

FIG. 4a is a schematic view of an embodiment of a multi-function printer according to the invention in which the scan module is in a first position;

FIG. 4b is a schematic view of an embodiment of a multi-function printer according to the invention in which the link is omitted;

FIG. 4c is a partial enlarged view of FIG. 4b;

FIG. 5a is a schematic view of an embodiment of a multi-function printer according to the invention in which the scan module is in a support position;

FIG. 5b is a schematic view of an embodiment of a multi-function printer according to the invention in which the link is omitted;

FIG. 5c is a schematic view of an embodiment of a multi-function printer according to the invention in which the scan module is in a second position;

FIGS. 6a to 6k are schematic views of an embodiment of a support mechanism according to the invention showing motions of the support mechanism;

FIGS. 6f-1 and 6f-2 are detailed views depicting motion of the support mechanism from FIG. 6e to FIG. 6f; and

FIG. 6g-1 is a partial enlarged view of FIG. 6g.

### DETAILED DESCRIPTION

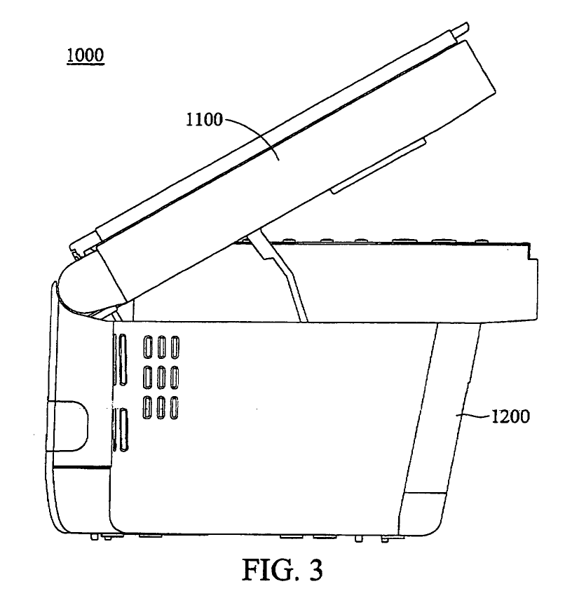

Referring to FIG. 3, a multiple-function printer 1000 comprises a scan module (first body) 1100 and a main body (second body) 1200. The scan module 1100 is pivoted to the main body 1200 and capable of rotating between a first position and a second position to close or open the multiple-function printer 1000.

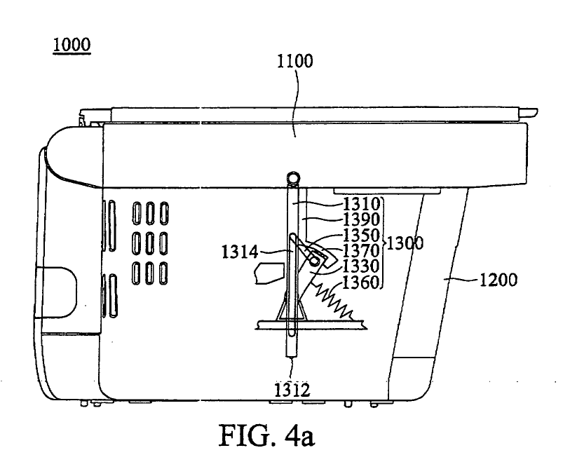

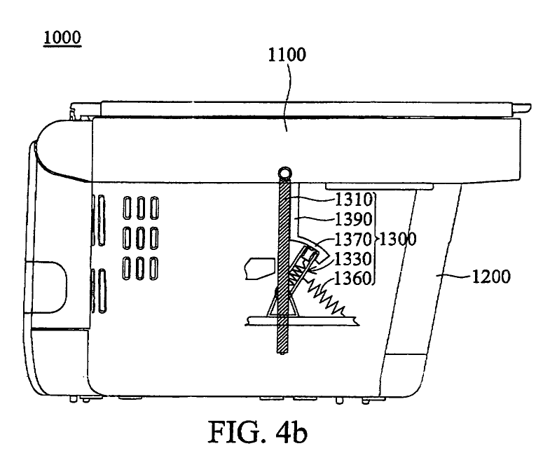

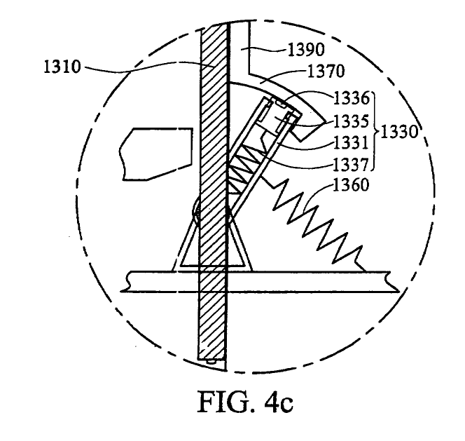

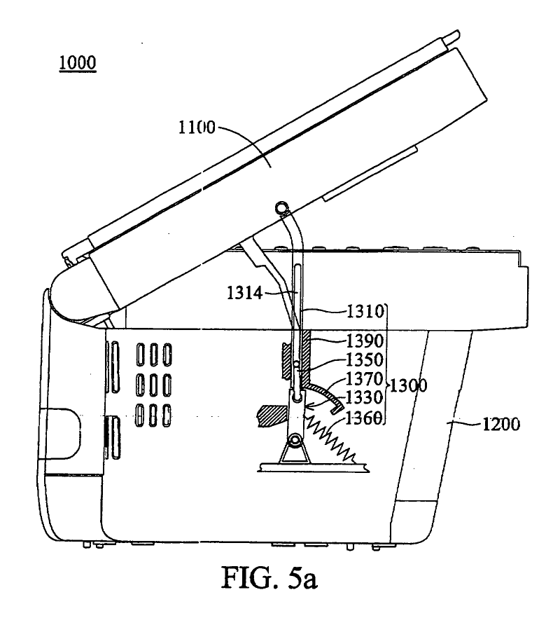

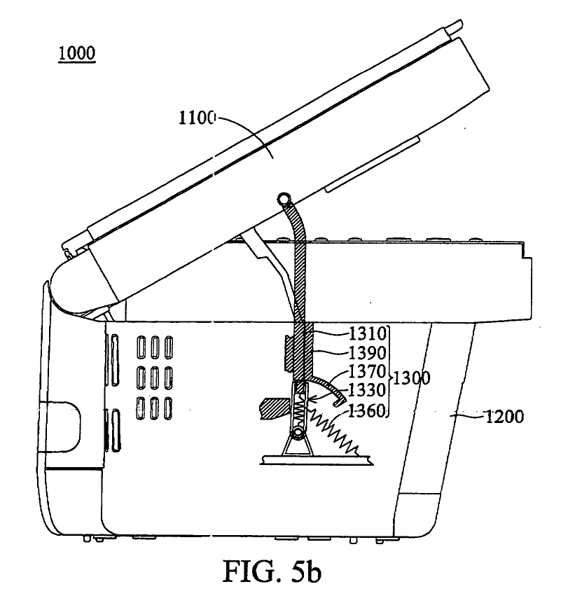

FIGS. 4a and 4b depict closed multiple-function printer 1000, and FIGS. 5a and 5b depict opened multiple-function printer 1000, wherein the scan module 1100 is supported by a support mechanism 1300 in a support position (slightly lower than the second position). The support mechanism 1300 comprises a support member 1310, a position module 1330, a link 1350, a first spring 1360 and a first track 1370. The support member 1310 is connected to the scan module 1100. The position module is pivoted to the main body 1200. One end of the link 1350 is pivoted to the position module 1330 and the other end is slidably pivoted to a groove 1314 on the support member 1310. The first spring 1360 connects the position module 1330 and main body 1200. The position module 1330 contacts the first track 1370. FIG. 4c is an enlarged view of the position module 1330. For the sake of clarity, the link 1350 is omitted. The position module 1330 comprises a main body 1331, a block 1335 and a second spring 1337. The block 1335 biased by the second spring 1337 is capable of sliding in the main body 1331, whereby the block 1335 maintains contact with the first track 1370 during rotation of main body 1331.

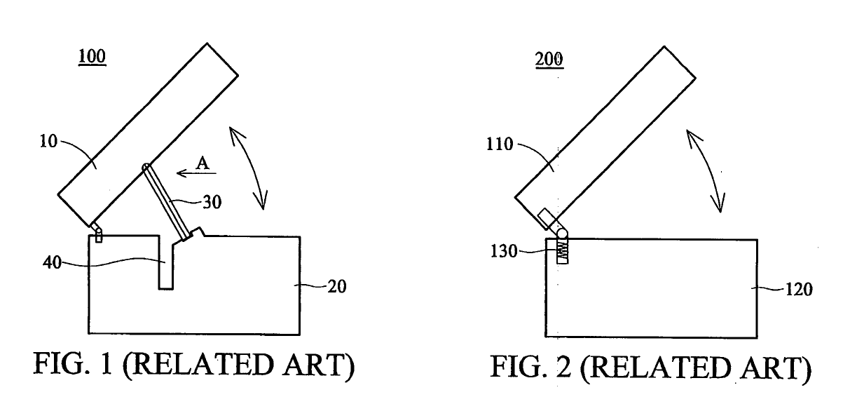

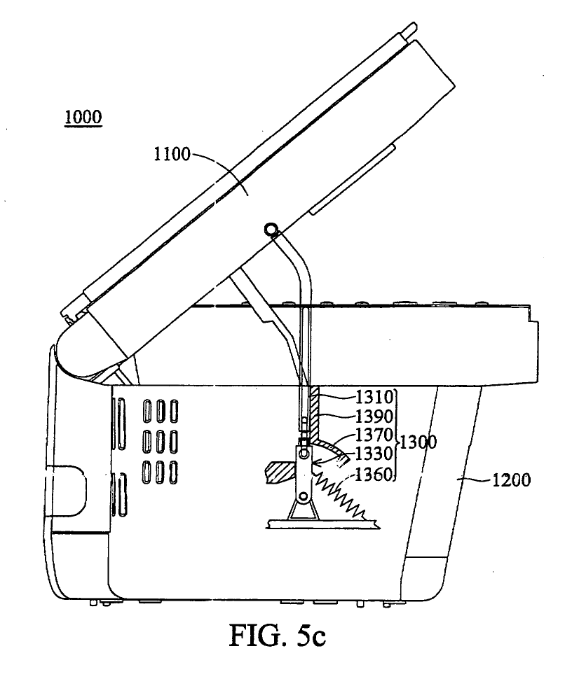

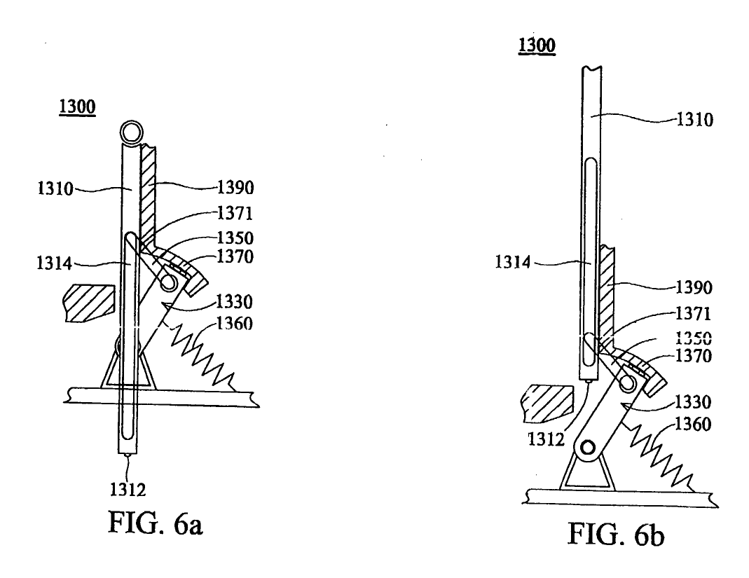

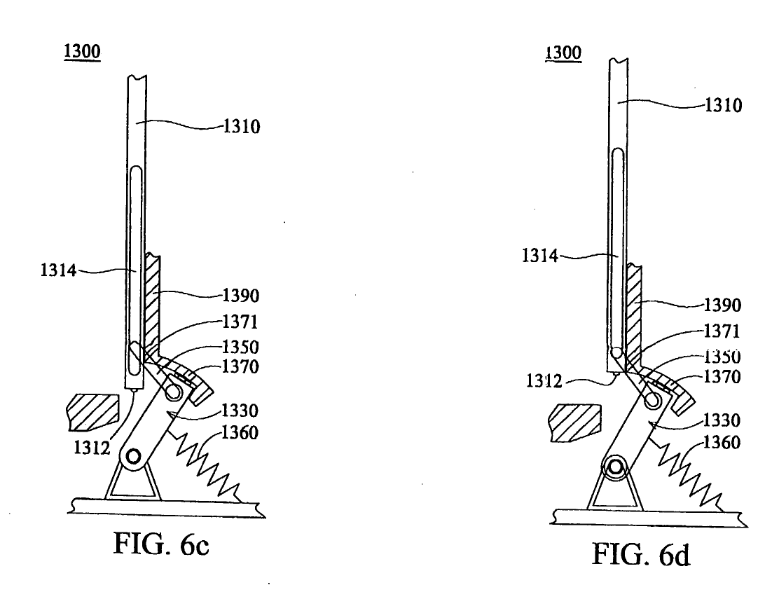

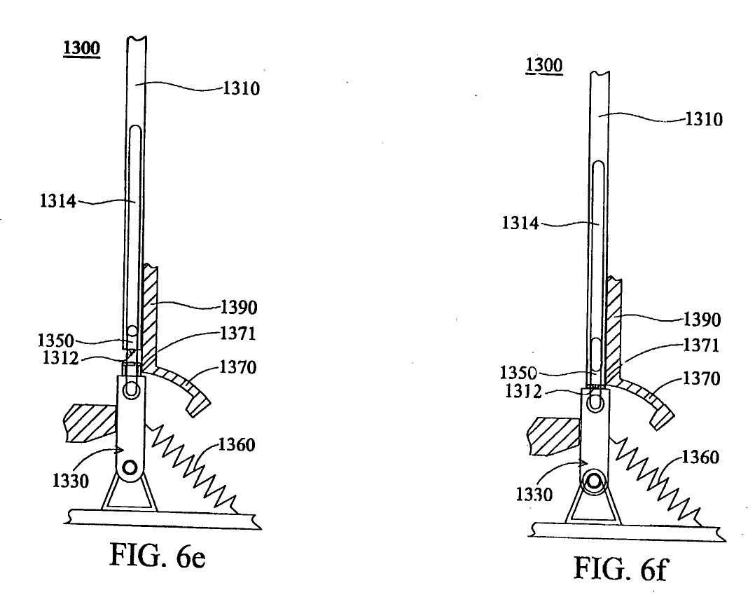

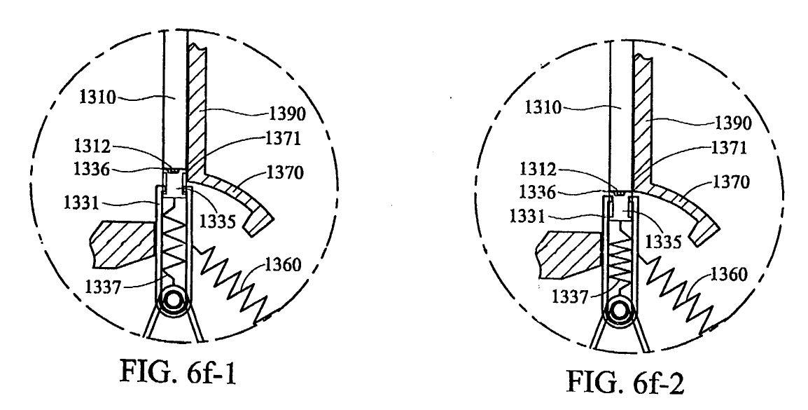

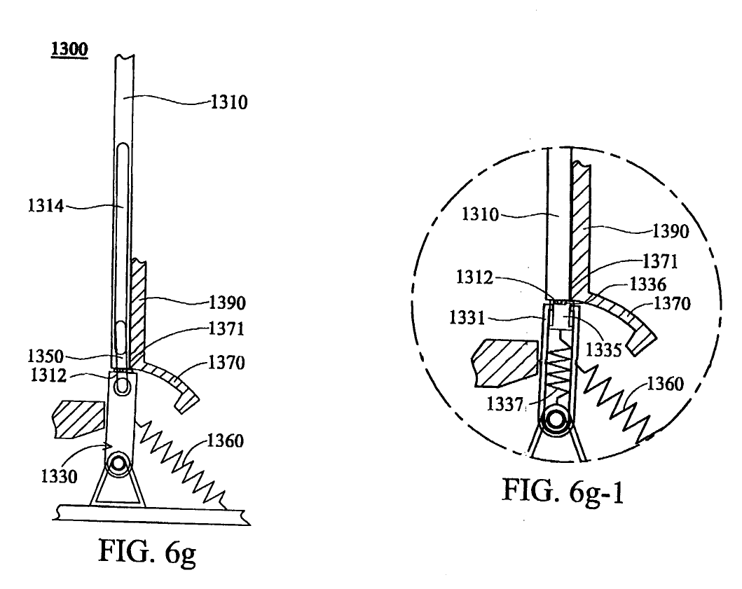

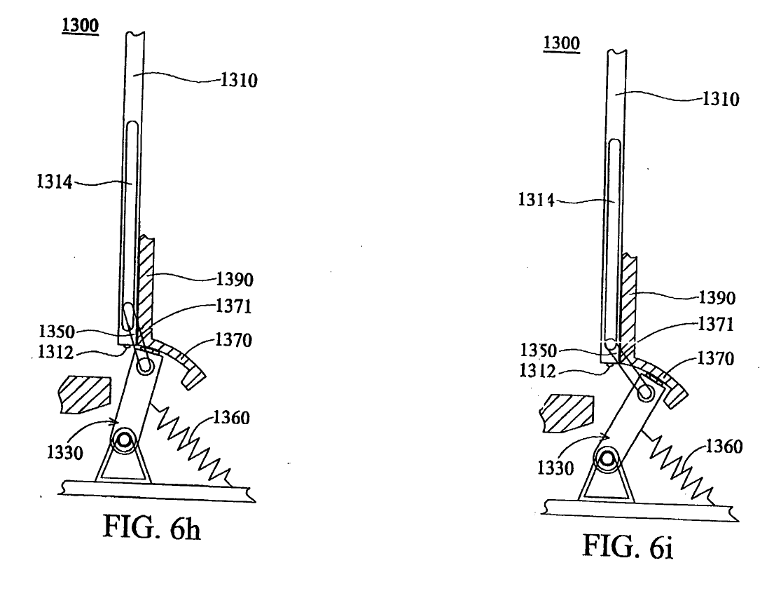

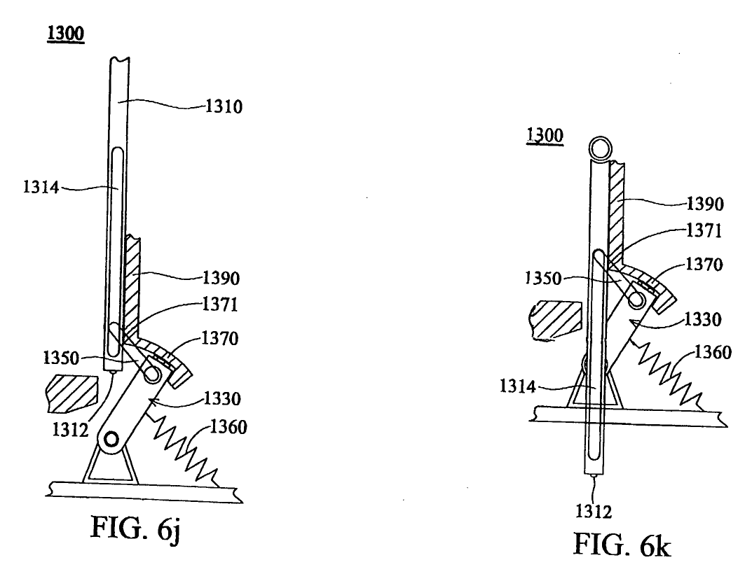

FIGS. 6a to 6k depict motion of the support mechanism 1300. When the scan module 1100 is lifted, the support member 1310 is moved by the scan module 1100 to rotate the position module 1330 counterclockwise via the link 1350 at which time the block 1335 is biased by the second spring 1337 to maintain contact with the first track 1370 as shown in FIGS. 6a to 6d. When the scan module 1100 is lifted to the second position (as shown in FIG. 5c), the position module 1330 is pulled vertical by the support member 1310 at which time the block 1335 beyond a first end 1371 of the first track 1370 is pushed to protrude from the main body 1331 by the second spring 1337 and abuts the first end 1371 via the return force of the first spring 1360. Thus, the position module 1330 is maintained vertically as shown in FIG. 6e. The scan module 1100 is pushed to slightly lower down the support member 1310. A key 1312 is disposed in one end of the support member 1310 and a depression 1336 is defined on top of the block 1335. When the support member 1310 is lowered, the key 1312 enters the depression 1336 so as to join the support member 1310 with the position module 1330 (as shown in FIGS. 6f and 6f-1). The block 1335 is pushed back to the main body 1331 by the weight of the scan module 1100 and unable to abut the first end 1371 (as shown in FIG. 6f-2), the first spring 1360, thereby, pulls the position module 1330 clockwise. As the key 1312 abuts an inner wall of the depression 1336, the support member 1310 and the position module 1330 are static force-balanced so as to maintain the scan module 1100 in a supported position. Meanwhile, a part of the block 1335 contacts the first track 1370 again (as shown in FIGS. 6g and 6g-1).

When closed, the scan module 1100 is lifted to the second position again (as shown in FIG. 5c), and the key 1312 of the support member 1310 escapes from the depression 1336. The first spring 1360 pulls the position module 1330 clockwise and back to original position. The scan module 1100 is lowered to the first position to close the multi-function printer as shown in FIGS. 6h to 6k.

In addition, the support mechanism 1300 further comprises a second track 1390 disposed in the main body 1200 for the support member 1310 sliding thereon.

Although the embodiment is described in terms of a multi-function printer, the invention is, however, not limited thereto. The invention is also applicable to an all-in-one laser printer with an automatic document feeder or a scanner with a cover.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A support mechanism for an electronic device comprising a first body and a second body to which the first body is pivoted, wherein the first body rotates between a first position and a second position with respect to the second body to close or open the electronic device respectively, comprising:
a support member connected to the first body;
a position module pivoted to the second body; and
a first spring connected to the position module and the second body, wherein when the electronic device is opened, the support member is moved by the first body rotating from the first position to the second position, thereby the position module rotates and joins with the support member to position the first body, and when the support member is released from the position module, the first spring pulls the position module back, thereby the first body rotates from the second position to the first position to close the electronic device.

2. The support mechanism as claimed in claim 1, wherein the position module comprises a main body pivoted to the second body and connected to the first spring and a block slidably disposed in the main body, wherein when the first body rotates to the second position, the block joins the support member to position the first body, thereby opening the electronic device.

3. The support mechanism as claimed in claim 2 further comprises a first track, wherein during the rotation of the position module from the first position to the second position, the block contacts the first track.

4. The support mechanism as claimed in claim 3, wherein the first track comprises a first end, and when the first body moves to the second position, the block moves beyond the first end and escapes from the first track to join the support member, thereby positioning the first body.

5. The support mechanism as claimed in claim 1, wherein the position module further comprises a second spring disposed in the main body to bias the block to contact the first track, and when the block moves beyond the first end, the second spring pushes the block to protrude from the main body and abut the first end by return force of the first spring, thereby facilitating the joining of the support member and the block.

6. The support mechanism as claimed in claim 5, wherein the support member comprises a key and the block comprises a depression, and the block joins the support member with the key inserted into the depression, the block is pushed into the main body by the support member and contacts the first track.

7. The support mechanism as claimed in claim 1 further comprising a second track within the second body for the support member moving thereon.

8. The support mechanism as claimed in claim 1, wherein the second track is connected to the first track.

9. The support mechanism as claimed in claim 1 further comprising a link with one end pivoted to the position module and the other end sliably pivoted on the supporting member, and during rotation of the first body from the first position to the second position, the first body moves the support member via the link so as to rotate the position module.

10. An electronic device, comprising:
a first body;
a second body to which the first body is pivoted capable of rotating between a first position and a second position with respect to the second body to close or open the electronic device respectively;
a support member connected to the first body;
a position module pivoted to the second body; and
a first spring connected to the position module and the second body, wherein when the electronic device is opened, the support member is moved by the first body rotating from the first position to the second position, thereby the position module rotates and joins the support member to position the first body, and when the support member is released from the position module, the first spring pulls the position module back, thereby the first body rotates from the second position to the first position to close the electronic device.

11. The electronic device as claimed in claim 10, wherein the position module comprises a main body pivoted to the second body and connected to the first spring, and a block slidably disposed in the main body, wherein when the first body rotates to the second position, the block joins the support member to position the first body, thereby opening the electronic device.

12. The electronic device as claimed in claim 11 further comprises a first track, wherein during the rotation of the position module from the first position to the second position, the block contacts the first track.

13. The electronic device as claimed in claim 12, wherein the first track comprises a first end, and when the first body moves to the second position, the block moves beyond the first end and escapes from the first track to join the support member, thereby positioning the first body.

14. The electronic device as claimed in claim 13, wherein the position module further comprises a second spring disposed in the main body and biasing the block to contact the first track, and when the block moves beyond the first end, the second spring pushes the block to protrude from the main body and abut the first end by return force of the first spring, thereby facilitating the joining of the support member and the block.

15. The electronic device as claimed in claim 14, wherein the support member comprises a key and the block comprises a depression, and the block joints the support member with the key inserted into the depression.

16. The electronic device as claimed in claim 10 further comprising a second track within the second body supporting the member moving thereon.

17. The electronic device as claimed in claim 16, wherein the second track is connected to the first track.

18. The electronic device as claimed in claim 10 further comprising a link with one end pivoted to the position module and the other end sliably pivoted on the supporting member, and during rotation of the first body from the first position to the second position, the first body moves the support member via the link so as to rotate the position module.
